(19) United States
(12) Patent Application Publication
(10) Pub. No.: US 2010/0243762 A1
(43) Pub. Date: Sep. 30, 2010

(54) Irrigation Nozzle With Hydrofoil

(75) Inventor: Travis L. Onofrio, Whittier, CA (US)

Correspondence Address: INSKEEP INTELLECTUAL PROPERTY GROUP, INC, 2281 W. 190TH STREET, SUITE 200, TORRANCE, CA, 90504, US

(73) Assignee: The Toro Company

(21) Appl. No.: 12/749,314

(22) Filed: Mar. 29, 2010

Related U.S. Application Data
(60) Provisional application No. 61/164,288, filed on Mar. 27, 2009.

(51) Int. Cl. B05B 1/00

(52) U.S. Cl. 239/518

(57) ABSTRACT

A sprinkler nozzle is described, having a hydrofoil member located on a lower surface near the nozzle exit aperture. As the water exits the nozzle, a portion of that water moves over the hydrofoil, causing it to be gently directed downwards with minimal turbulence. A portion of this water may be further directed by ramps extending from the face of the nozzle. Ultimately, the water is distributed to close-in areas of turf at about the same rate as other distances in the watering radius, eliminating “close-in” overwater that occurs in prior art nozzles. Additionally, by providing a less abrupt flow-directing feature than the prior art, the rate and therefore the force of the nearby watering flow is less (i.e., more gentle) than prior art nozzles.

### RELATED APPLICATIONS

This application claims priority to U.S. Provisional Application Ser. No. 61/164,288 filed Mar. 27, 2009 entitled Irrigation Nozzle With Hydrofoil, which is hereby incorporated herein by reference in its entirety.

### BACKGROUND OF THE INVENTION

Sprinkler systems for turf irrigation are well known. Typical systems include a plurality of valves and sprinkler heads in fluid communication with a water source, and a centralized controller connected to the water valves. At appropriate times the controller opens the normally closed valves to allow water to flow from the water source to the sprinkler heads. Water then issues from the sprinkler heads in a predetermined fashion.

There are many different types of sprinkler heads, including above-the-ground heads and “pop-up” heads. Pop-up sprinklers, though generally more complicated and expensive than other types of sprinklers, are thought to be superior. There are several reasons for this. For example, a pop-up sprinkler's nozzle opening is typically covered when the sprinkler is not in use and is therefore less likely to be partially or completely plugged by debris or insects. Also, when not being used, a pop-up sprinkler is entirely below the surface and out of the way.

The typical pop-up sprinkler head includes a stationary body and a “riser” which extends vertically upward, or “pops up,” when water is allowed to flow to the sprinkler. The riser is in the nature of a hollow tube which supports a nozzle at its upper end. When the normally-closed valve associated with a sprinkler opens to allow water to flow to the sprinkler, two things happen: (i) water pressure pushes against the riser to move it from its retracted to its fully extended position, and (ii) water flows axially upward through the riser, and the nozzle receives the axial flow from the riser and turns it radially to create a radial stream. A spring or other type of resilient element is interposed between the body and the riser to continuously urge the riser toward its retracted, subsurface, position, so that when water pressure is removed the riser assembly will immediately return to its retracted position.

The riser assembly or spray head of a pop-up or above-the-ground sprinkler head can remain rotationally stationary or can include a portion that rotates in continuous or oscillatory fashion to water a circular or partly circular area and is generally known as a rotor. More specifically, the riser assembly of the typical rotary sprinkler includes a first portion (e.g. the riser), which does not rotate, and a second portion, (e.g., the nozzle assembly) which rotates relative to the first (non-rotating) portion.

The rotating portion of a rotary sprinkler riser typically carries a nozzle at its uppermost end. The nozzle throws at least one water stream outwardly to one side of the nozzle assembly. As the nozzle assembly rotates, the water stream travels or sweeps over the ground, creating a watering arc.

One drawback with this type of sprinkler nozzle is uneven coverage or distribution of water. Typically, if water is thrown in a coherent stream at some trajectory relative to the surface to be watered, the stream will tend to water a doughnut shaped ring around the sprinkler with less water being deposited close to the sprinkler. This is obviously a disadvantage since the vegetation closest to the sprinkler will be under-watered. One technique of compensating for this involves increasing the length of time the sprinkler is allowed to run. However, increasing water usage to ensure proper watering of vegetation closest to the sprinkler also means that vegetation further away from the sprinkler (i.e., in the outer radial portions of the watering pattern) will then be over-watered. It is of further importance that a person installing sprinklers have an understanding of the distribution rates along the water stream radius so as to be able to arrange the sprinklers to distribute a known amount of water at a known rate.

To compensate for uneven water distribution, sprinkler systems must be arranged so that the spray patterns of each sprinkler overlap with one another. Known in the industry as head-to-head coverage or head-to-head spacing, this type of sprinkler arrangement ensures overlap of watered areas to produce adequate water application. While this arrangement results in improved coverage, the overall distribution remains uneven since the watering arcs from each sprinkler fail to perfectly overlap each other (i.e., the result is many partially overlapping circular or arc shaped patterns that fail to overlap all areas of a sprinkler's watering arc).

Prior art nozzles have attempted to address this issue by creating a nozzle that can water “close-in” areas near the sprinkler. For example, U.S. Pat. No. 7,325,753, the contents of which are incorporated herein by reference, illustrates a series of angled surfaces imbedded in the front face of the nozzle. These angled surfaces cut into the water flow, creating turbulence and directing water to areas nearby to the sprinkler. However, this prior art nozzle design tends to direct this close-in water at a high rate, resulting in over-watering of the close-in areas, washout of the nearby soil and damage to the nearby turf. In one test conducted by the inventor, this prior art nozzle, having a target precipitation rate of about 0.37 inches/hour, was found to have a rate of about 0.65 inches/hour at 1 foot and 2 feet away from the sprinkler. Yet the remaining precipitation rates further from the sprinkler were closer to the target precipitation rate. In other words, this prior art nozzle can result in a greater amount of water at an area close in to the sprinkler, as compared to the target precipitation rate. Hence, this prior art nozzle can result in undesirable watering that is unexpected and therefore unplanned for by the contractors installing an irrigation system.

In view of the above, there is a need for an improved sprinkler nozzle for both above-the ground and pop-up rotary sprinkler systems. In particular, it is desirable that the nozzle applies water in an expected pattern so that a uniform watering pattern can be achieved with head-to-head coverage. In addition, the nozzle should also be configured to include a broad throw pattern with even water distribution over the entire area. Furthermore, it is desirable that the nozzle reduce water turbulence in order to deliver optimum water-efficient coverage over the irrigation surface.

### SUMMARY OF THE INVENTION

In a preferred embodiment of the present invention, a sprinkler nozzle is described, having a hydrofoil member located on a lower surface near the nozzle exit aperture. As the water exits the nozzle, a portion of that water moves over the hydrofoil, causing it to be gently directed downwards with minimal kinetic energy to the turbulence. A portion of this water may be further directed by ramps extending from the face of the nozzle. Ultimately, the water is distributed to close-in areas of turf at about the same rate as other distances in the watering radius. Additionally, by providing a less abrupt flow directing feature than the prior art, the rate and therefore the force of the nearby watering flow is less (i.e., more gentle) than prior art nozzles.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 illustrates a cross sectional view of a sprinkler with a nozzle according to the present invention;

FIG. 2 illustrates a front perspective view of a nozzle according to the present invention;

FIG. 3 illustrates a front view of the nozzle of FIG. 2;

FIG. 4 illustrates a back perspective view of the nozzle of FIG. 2;

FIG. 5 illustrates a back view of the nozzle of FIG. 2;

FIG. 6 illustrates a side, cross sectional view of the nozzle of FIG. 2;

FIG. 7 illustrates a magnified view of a hydrofoil from FIG. 6;

FIG. 8 illustrates a cross sectional view of a prior art nozzle;

FIG. 9 illustrates a magnified view of a region from FIG. 8;

FIG. 10 illustrates a water distribution chart for a prior art nozzle;

FIG. 11 illustrates a water distribution chart for the nozzle of FIG. 2;

FIG. 12 illustrates a fixed head or mini stream rotor having a circular hydrofoil according to the present invention;

FIG. 13 illustrates a rotating turret sprinkler with a hydrofoil at each of the plurality of jet holes according to the present invention; and,

FIG. 14 illustrates a cross sectional view of a jet hole of FIG. 13.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

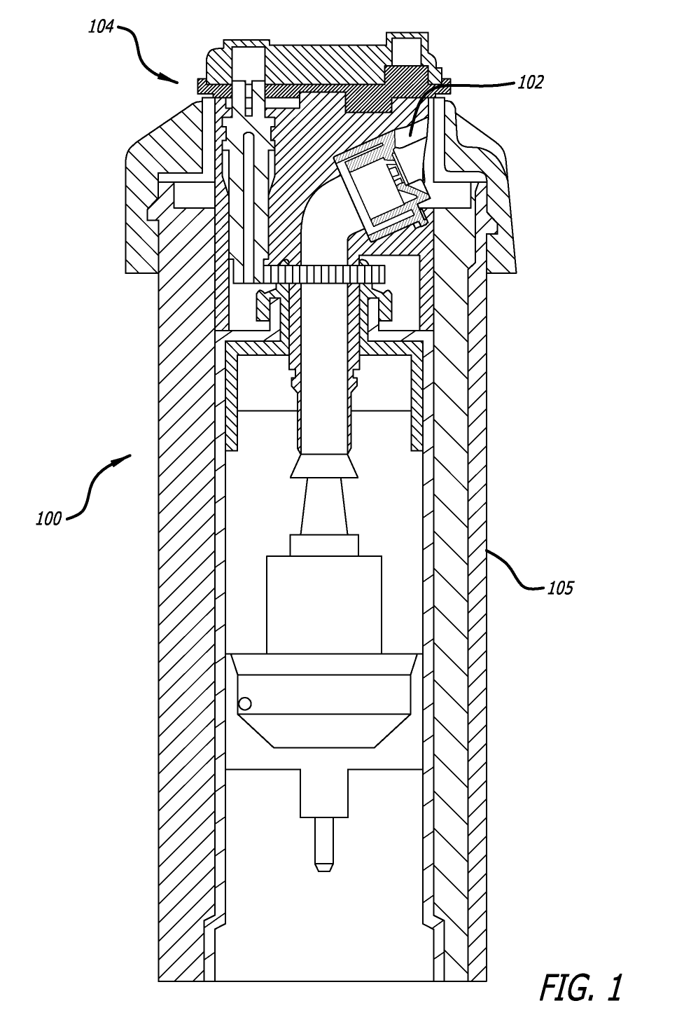

Turning to FIG. 1, a preferred embodiment of a pop-up sprinkler 100 is shown having a nozzle 102 according to the present invention. The nozzle 102 is located in a riser portion 104 that rises within the base 105 when irrigating and lowers within the base 105 when inactive.

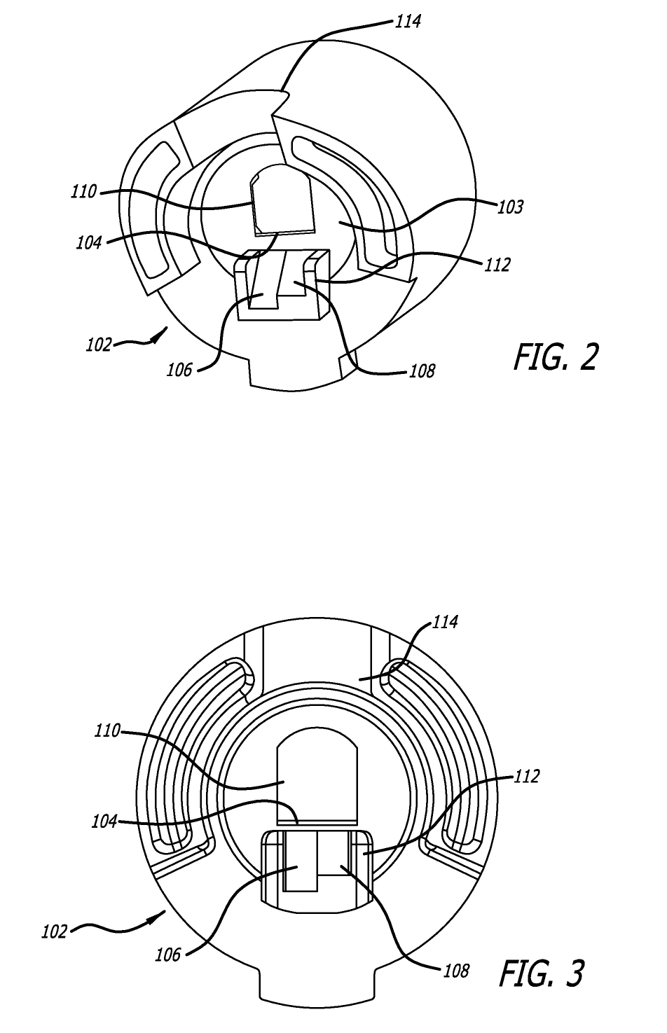

Referring to FIGS. 2 and 3, the nozzle 102 is preferably generally cylindrical in shape to conform to the exit passage of the sprinkler 100. The nozzle is preferably locked into place on the sprinkler 100 via locking groove 114 which allows a screw or similar member to engage the nozzle 102 and prevent movement.

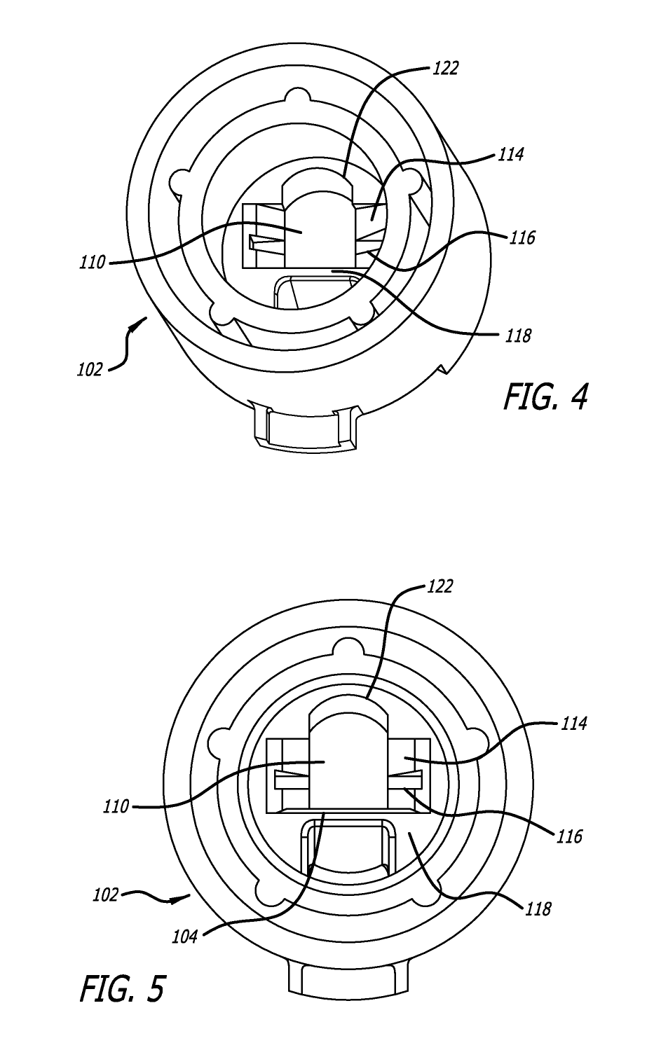

As best seen in FIGS. 4 and 5, the inner passage of the nozzle 102 includes angled surfaces 114 and 122 adjacent the sides and top of aperture 110, respectively. These angled surfaces help direct the flow of water from the larger interior passage of the nozzle and out the aperture 114. The side angled surfaces 114 also include a slotted area 116 which helps improve the midrange water distribution.

As seen in FIGS. 2-7, nozzle 102 includes a hydrofoil 104 and ramps 106, 108 that help direct water to an area closely surrounding the sprinkler 100. More specifically, the hydrofoil 104 creates an area of negative pressure within the water stream prior to exiting from the nozzle 102 which better directs some of the water stream towards the ramps 106 and 108 and down to an area close to the base of the sprinkler 100. In this respect, the sprinkler 100 achieves a relatively even and desirable water distribution pattern when incorporated into a head-to-head irrigation system.

While item 104 is referred to as a hydrofoil, it should be understood that this term refers to a generally curved surface over which water flows. Further, the shape of the curve of this surface may be such that it changes the properties of at least a portion of the water that flows over it. In this respect, the hydrofoil may also be referred to as a curved ridge, a hump, an angled water feature or similar terminology.

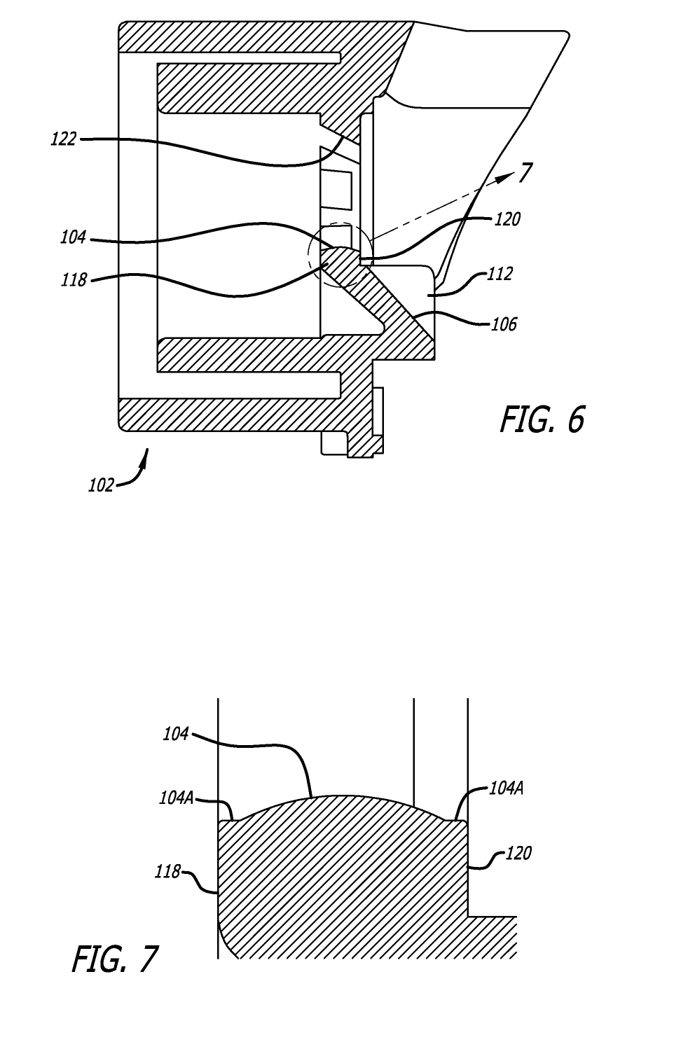

As seen best in FIGS. 6 and 7, the hydrofoil 104 is located on the top surface of nozzle portion 118, at the base of nozzle aperture 110. The hydrofoil 104 preferably extends along most of, or the entire width of the aperture 110. However, it should be understood that the hydrofoil 104 can be located at a small portion of the width of the aperture 110 or at multiple locations along its width.

Referring to FIG. 7, the hydrofoil 104 is preferably preceded and followed by a relatively flat surface 104A. These flat surfaces 104 can have a length as long as the aperture 110 and a width of about 0.017 inch. However, other widths are possible, such as within an example range of about 0.010 to about 0.020 inch.

Generally, the hydrofoil 104 is sized and shaped to provide a region of low kinetic energy of turbulence and reduced pressure within the water flow to better reach closer areas of turf around the sprinkler 100. Since the hydrofoil 104 provides a less “abrupt” transition for the water than prior art nozzles, the water is directed downwards with less force. Hence “washout” of soil, damage to the turf and over-watering that can otherwise occur near the sprinkler is reduced. In other words, the shape of the hydrofoil 104 directs a portion of the water around its curved surface with a slight downward trajectory, similar to the wing of a plane or the hydrofoil of a boat, resulting in more even and desirable water distribution when placed in a head-to-head irrigation system.

The curve of hydrofoil 104 can by symmetrical (i.e., the same curve shape on the inner hydrofoil surface as the outer hydrofoil surface. Alternately, the hydrofoil 104 can have an asymmetric shape similar to a plane wing. For example, the hydrofoil 104 can have a rounded leading edge, a large upper camber, a smaller mean camber and a smallest trailing edge. It should be understood that the shape of this hydrofoil 104 can be modified to selectively direct water to a desired, close-in location and to reduce the force of that water by a desired amount.

In one preferred embodiment, the hydrofoil 104 has a thickness (i.e., front to back) between about 0.040 and about 0.080 inch, a height between about 0.005 and about 0.010 inch and a radius of curvature between about 0.050 and about 0.080 inch. In one preferred embodiment, the hydrofoil 104 has a thickness of about 0.060 inch, a height of about 0.005 inch and a radius of curvature of about 0.070 inch.

As a portion of the water flow moves over the hydrofoil 104, it is directed downwards against the ramps 106 and 108, as seen best in FIGS. 2 and 3. Preferably, two ramps are included, each having a different angle relative to the face 103 of the nozzle 102. Depending on this ramp angle, the water is further directed to one or more areas nearby to the sprinkler 100. Optionally, these ramps can be of different lengths and widths to achieve different watering patterns. Any number of ramps can be used, such as a single ramp, three ramps, or four or more ramps. In a preferred embodiment, the angle of the ramps relative to the face 103 of the nozzle is between about 30 and 60 degrees. The water flow is further directed by sidewalls 112 which are located on each side of the ramps to maintain the desired distribution pattern.

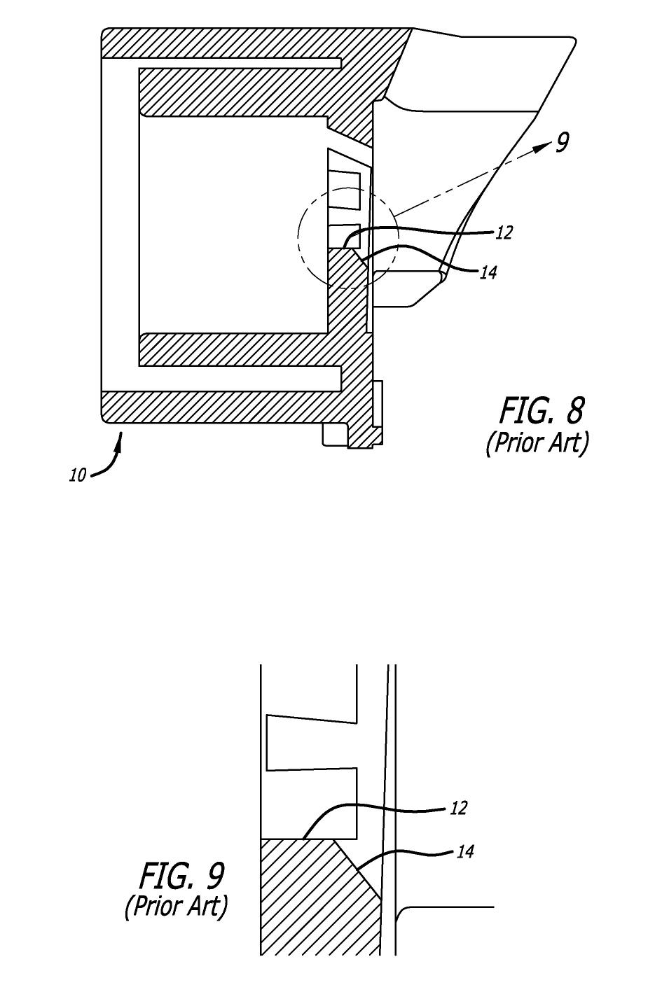

Turning to FIGS. 8 and 9, a prior art nozzle 10 is shown, similar to that of U.S. Pat. No. 7,325,753, the contents of which are incorporated by reference. These prior art nozzles 10 typically include a lower flat surface 12 at the nozzle aperture. Additionally, these nozzles also include ramps 14 that are indented within the face of the nozzle 10 (i.e., do not extend past the face of the nozzle 10). These features abruptly “cut” into the water stream as it exits the nozzle 10, sending a high pressure stream of water close to the base of the sprinkler. In this respect, the nozzle 10 directs a higher volume of water relative to the remaining distribution areas. Further, the force of this “close-in” water often results in damage and washout of the nearby turf and soil.

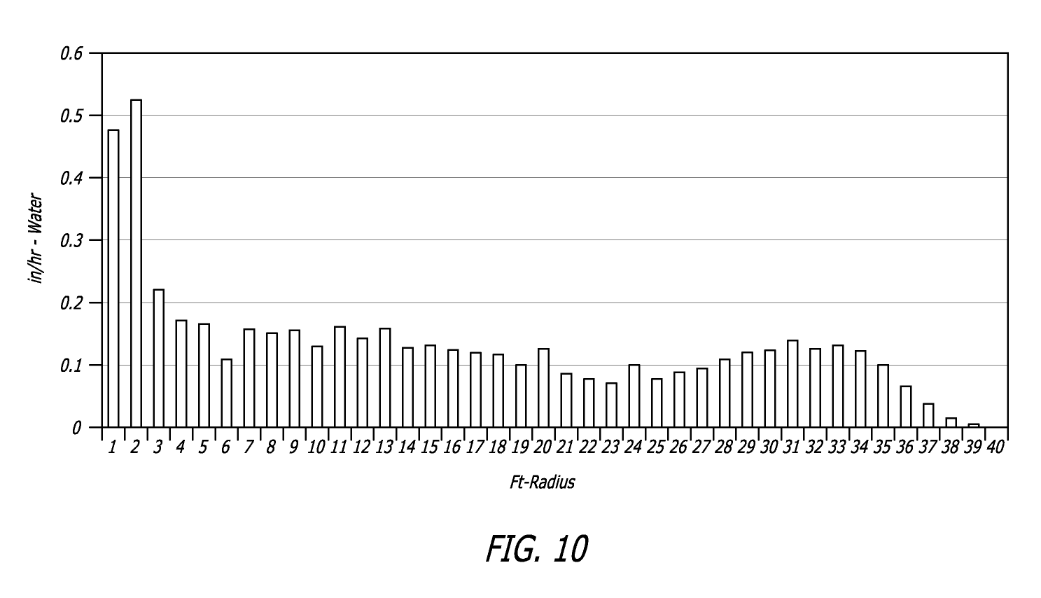

To better illustrate the dramatic benefits of the present invention over the prior art, the inventor has conducted a water distribution test for both the prior art nozzle 10 and the nozzle 102 of the present invention. FIG. 10 illustrates the test data for the prior art nozzle 10, showing the rate of water flow (inches/hour) at various distances from the sprinkler (feet). As seen in this figure, the distribution between about 4 feet and 35 feet is relatively uniform. However, the amount of water distributed at 1, 2 and 3 feet is dramatically higher than the remaining distribution length. Hence, the prior art nozzle 10 produces significantly uneven water distribution in a head-to-head irrigation system. As previously discussed, such a high distribution rate can cause soil washout, turf damage and over-watering. The target precipitation rate for this nozzle 10 arranged for head-to-head coverage is about 0.37 in/hour at any point on the turf. Yet, in this test conducted by the inventor (in non head-to-head arrangement), the rate nearly doubled this desired target at 1 and 2 foot locations. In a head-to-head sprinkler configurations (i.e., overlapping watering arcs) this watering rate may be substantially more.

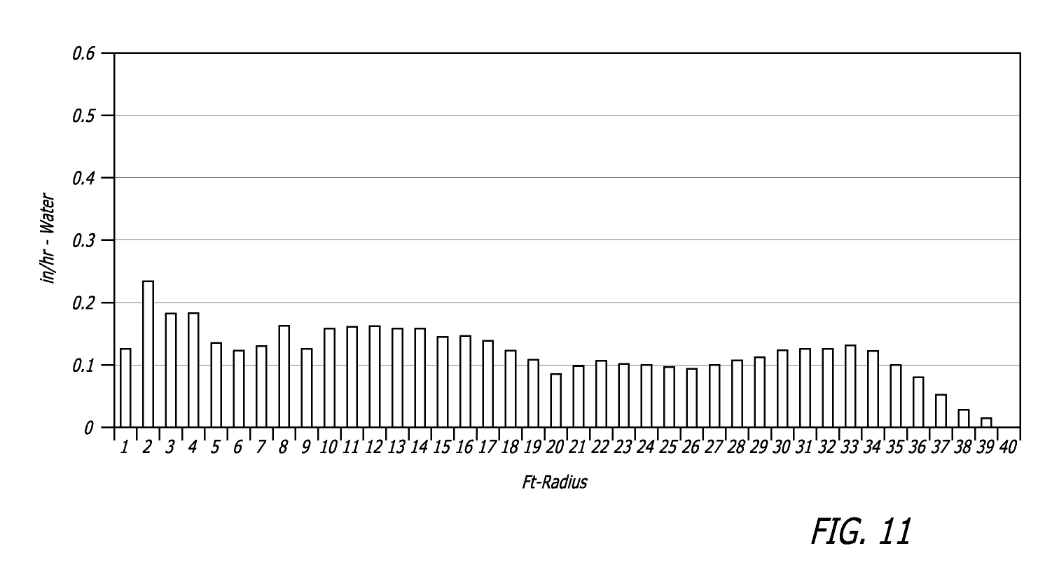

In contrast, FIG. 11 illustrates the test data for the nozzle 102 of the present invention, showing the rate of water flow (inches/hour) at various distances from the sprinkler (feet). As seen in this figure, the water distribution remains relatively even between 1 and 35 feet, especially at 1, 2 and 3 feet from the sprinkler. Hence, the nozzle 102 overcomes many of the disadvantages associated with the prior art (e.g., turf damage, soil washout, over-watering close-in turf, etc.). In this respect, with head-to-head overlapping sprinkler coverage, this distribution pattern will supply water at a rate close to the example target rate of 0.37 in/hour for this type of nozzle. It should be noted that target flow rates for nozzles can vary by style and manufacturer.

In operation, water enters the sprinkler 100, flows up through the passages in the sprinkler base 105 and riser 104 until it reaches the nozzle 102. Surfaces 122, 114 and 116 direct or guide the water to the nozzle aperture 110. As the water exits the aperture 110, a lower portion of the water moves over the hydrofoil 104, reducing some of the pressure in the water flow (i.e., creating an area of negative pressure), thereby directing a portion of the exiting water flow downward relative to the nozzle aperture 110. At least a portion of this water flow influence by the hydrofoil 104 contacts one or more of the ramps 106 and 108 which further deflect the water to a desired area. Since the rate and direction of this hydrofoil-influenced water is changed, water is more evenly distributed to areas of turf close to the sprinkler 100 (e.g., 1, 2 and 3 feet) relative to the distances further away from the sprinkler 100.

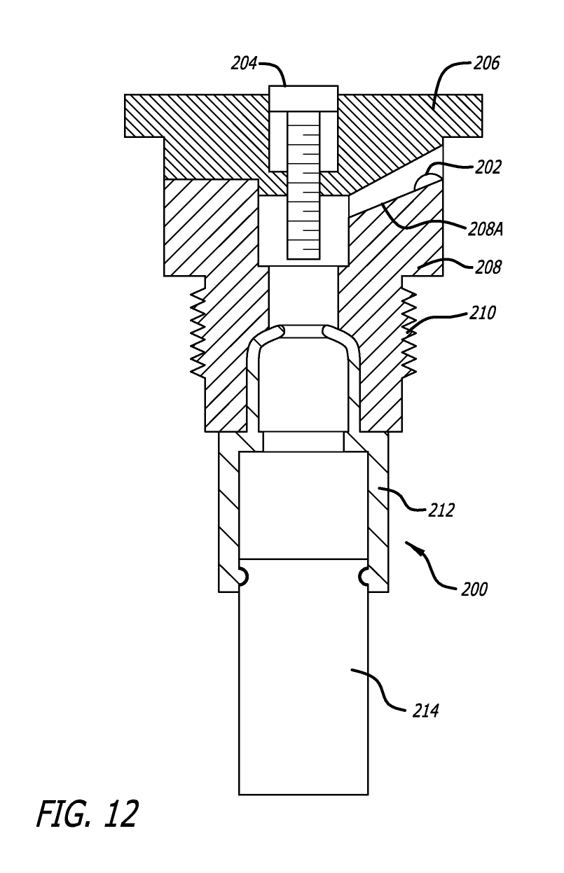

While the hydrofoil has been shown for use in a traditional, tubular nozzle for a rotary sprinkler, it should be understood that this feature can be used in connection with other sprinkler designs such as the fixed spray sprinker 200 see in FIG. 12 or a mini-stream rotor as seen in U.S. application Ser. No. 12/210,085 entitled Sprinkler with Dual Shafts, the contents of which are incorporated by reference. As seen in FIG. 12, the fixed spray sprinkler 200 includes a base 212 coupled to a screen 214 and an upper base 208 with threads 210 that couple to a fixed spray riser. Water enters a passage in the base 212 and 208, deflecting against the deflector 206 and exiting the sprinkler 200. A flow and radius adjustment 204 controls the size of the watering arc and the flow rate.

A circular hydrofoil 202 is located near the inner diameter of the top surface 208A of the upper base 208. Preferably, the circular hydrofoil 202 is positioned near the outer edge of the top surface 208A and has an overall circular shape that tracks the outer edge of the top surface 208A. The shape and configuration of the hydrofoil 202 (e.g., the height, depth and curvature) preferably achieves improved and even close-in watering results. More specifically, the hydrofoil 208 can be shaped and configured as previously described in this specification.

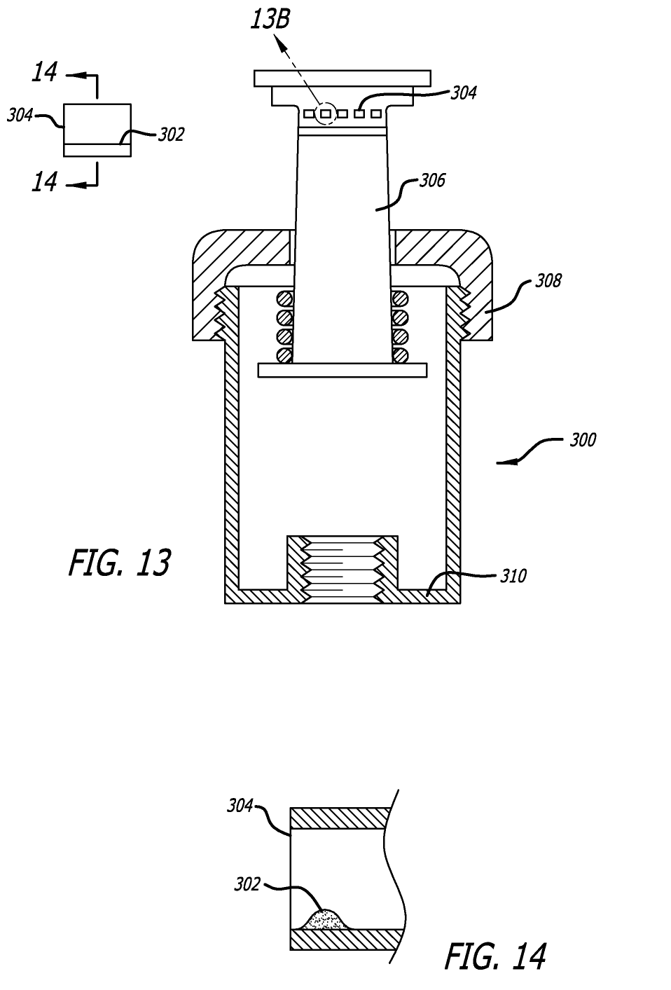

FIGS. 13 and 14 illustrates a sprinkler 300 with a plurality of jet holes 304 or water passages. The sprinkler 300 includes a body 310, a cap 308 and a riser 306 which raises and lowers within the body 310. Each jet hole 304 includes a hydrofoil 302 near its outer edge to modify the water flow. The shape and configuration of the hydrofoils 302 (e.g., the height, depth and curvature) preferably achieves improved and uniform close-in watering results. More specifically, the hydrofoil 302 can be shaped and configured as previously described in this specification.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A sprinkler comprising:
a body having an outlet for distributing water; and
a hydrofoil disposed near said outlet for contacting said water and modifying a distribution pattern of said water.

2. The sprinkler of claim 1, wherein said hydrofoil comprises an area having a curve, said curve rounded so as to impart a downward trajectory on at least part of a water flow passing over said hydrofoil.

3. The sprinkler of claim 1, wherein said hydrofoil comprises an asymmetric, curved shape.

4. The sprinkler of claim 3, wherein said hydrofoil further comprises a rounded leading edge, an upper camber having a first height, a mean camber having a second height that is smaller than said first height, and a trailing edge having a third height that is smaller than said second height.

5. The sprinkler of claim 4, wherein said trailing edge is located closer to said outlet than said rounded leading edge.

6. The sprinkler of claim 1, further comprising at least one ramp disposed on a surface adjacent to said outlet.

7. The sprinkler of claim 6, wherein said at least one ramp further comprises a first ramp and a second ramp.

8. The sprinkler of claim 1, further comprising a first surface located on a left side of said outlet and a second surface located on a right side of said outlet; said first surface and said second surface being angled towards said outlet.

9. The sprinkler of claim 8, further comprising a first slot within said first surface and a second slot within said second surface, said first and second slot configured to increase midrange water distribution.

10. A sprinkler comprising:
a body having an outlet for distributing water; and
a nozzle disposed in said outlet;
a hydrofoil disposed within a passage of said nozzle for modifying a distribution pattern of said water.

11. The sprinkler of claim 10, wherein said hydrofoil comprises a curved surface angled to create an area of negative pressure above said hydrofoil and within a flow of said water.

12. The sprinkler of claim 11, wherein said curved surface imparts a downward trajectory on at least part of a water flow passing over said hydrofoil.

13. The sprinkler of claim 12, further comprising a first flat surface disposed proximal to said hydrofoil and a second flat surface disposed distal to said hydrofoil.

14. The sprinkler of claim 13, wherein said hydrofoil further comprises a rounded leading edge, an upper camber having a first height, a mean camber having a second height that is smaller than said first height, and a trailing edge having a third height that is smaller than said second height.

15. The sprinkler of claim 14, wherein said trailing edge is located closer to a nozzle outlet than said rounded leading edge.

16. A sprinkler comprising:
a body having an outlet for distributing water; and
a curved ridge portion disposed near a lower portion of said outlet; said curved ridge portion having a curve being rounded so as to impart a downward trajectory on at least part of a flow of said water passing over said hydrofoil.

17. The sprinkler of claim 16, wherein said curved ridge portion is disposed within a nozzle.

18. The sprinkler of claim 16, further comprising a first flat region disposed immediately distal of said curved ridge portion and a second flat region disposed immediately proximal of said curved ridge portion.

19. The sprinkler of claim 16, wherein said curved ridge portion is symmetrically rounded.

20. The sprinkler of claim 17, wherein said curved ridge portion is asymmetrically rounded.
